(19) United States
(12) Patent Application Publication
(10) Pub. No.: US 2010/0148127 A1
(43) Pub. Date: Jun. 17, 2010

(54) Method For Encapsulating An Electronic Arrangement

(75) Inventors: Jan ELLINGER, Hamburg (DE); Klaus KEITE-TELGENBÜSCHER, Hamburg (DE); Bernard MÜSSIG, Seevetal (DE); Kerstin METZLER, Hamburg (DE)

Correspondence Address: Briscoe, Kurt G.;Norris McLaughlin & Marcus, PA, 875 Third Avenue, 8th Floor, New York, NY, 10022, US

(73) Assignee: tesa SE, Hamburg (DE)

(21) Appl. No.: 12/634,944

(22) Filed: Dec. 10, 2009

(30) Foreign Application Priority Data
Dec. 16, 2008 (DE) 10 2008 062 130.7

(51) Int. Cl. H01B 1/00; B32B 27/32; C08F 210/00; F21V 9/06

(52) U.S. Cl. 252/500; 156/242; 526/348; 252/589

(57) ABSTRACT

A method for encapsulating an electronic, optionally optoelectronic, arrangement against permeants, in which a pressure-sensitive adhesive composition based on a partly crystalline polyolefin is applied onto and/or around the regions of the electronic arrangement which are to be encapsulated, wherein the polyolefin has a density between 0.86 and 0.89 g/cm and a crystallite melting point of at least 90° C.

The present invention relates to a method for encapsulating an electronic arrangement and to the use of a pressure-sensitive adhesive composition for encapsulating an electronic arrangement.

Electronic arrangements, in particular optoelectronic arrangements, are being used more and more often in commercial products or are about to be introduced to the market. Such arrangements comprise inorganic or organic electronic structures, for example organic, organometallic or polymeric semiconductors or else combinations thereof. Depending on the desired application, these arrangements and products are embodied in rigid or flexible fashion, where there is an increasing demand for flexible arrangements. Such arrangements are produced for example by printing methods such as relief printing, intaglio printing, screen printing, planographic printing or else so-called “non impact printing” such as, for instance, thermal transfer printing, inkjet printing or digital printing. In many cases, however, use is also made of vacuum methods, such as e.g. chemical vapour deposition (CVD), physical vapour deposition (PVD), plasma-enhanced chemical or physical deposition methods (PECVD), sputtering, (plasma) etching or vapour deposition, wherein the patterning is generally effected by means of masks.

Examples that may be mentioned here of (opto)electronic applications that are already commercial applications or are interesting in terms of their market potential include electrophoretic or electrochromic structures or displays, organic or polymeric light-emitting diodes (OLEDs or PLEDs) in indication and display devices or as lighting, electroluminescent lamps, light-emitting electrochemical cells (LLEDs), organic solar cells, preferably dye or polymer solar cells, inorganic solar cells, preferably thin-film solar cells, in particular based on silicon, germanium, copper, indium and selenium, organic field effect transistors, organic switching elements, organic optical amplifiers, organic laser diodes, organic or inorganic sensors or else organically or inorganically based RFID transponders.

What can be regarded as a technical challenge for realizing sufficient lifetime and function of (opto)electronic arrangements in the field of inorganic and/or organic (opto)electronics, but especially in the field of organic (opto)electronics, is protecting the components contained therein against permeants. Permeants can be a multiplicity of low-molecular-weight organic or inorganic compounds, in particular water vapour and oxygen.

A large number of (opto)electronic arrangements in the field of inorganic and/or organic (opto)electronics, especially when using organic raw materials, are sensitive both to water vapour and to oxygen, where the penetration of water vapour is rated as a fairly major problem for many arrangements. Protection by means of an encapsulation is necessary during the lifetime of the electronic arrangement, therefore, since otherwise the performance deteriorates over the application period. Thus, for example as a result of an oxidation of the constituents for instance in the case of light-emitting arrangements such as electroluminescent lamps (EL lamps) or organic light-emitting diodes (OLEDs) the luminosity, in the case of electrophoretic displays (EP displays) the contrast or in the case of solar cells the efficiency can decrease drastically within a very short time.

In the case of inorganic and/or organic (opto)electronics, in particular in the case of organic (opto)electronics, there is a particular need for flexible adhesive solutions that constitute a permeation barrier to permeants such as oxygen and/or water vapour. In addition, there are a large number of further requirements for such (opto)electronic arrangements. The flexible adhesive solutions are therefore intended not only to achieve a good adhesion between two substrates, but additionally to fulfil properties such as high shear strength and peel strength, chemical resistance, ageing resistance, high transparency, simple processability and also high flexibility and pliability.

One approach that is common according to the prior art is therefore to place the electronic arrangement between two substrates that are impermeable to water vapour and oxygen. Afterwards, sealing is then effected at the edges. For inflexible structures, glass, metal substrates or film composites (for example backsheets composed of EVA, polyester and fluoropolymer layers in combination with rigid substrates such as glass and/or metal) are used, which in part offer a high permeation barrier but are very susceptible to mechanical loading. Furthermore, these substrates cause the entire arrangement to have a relatively large thickness. In the case of metal substrates, moreover, there is no transparency. For flexible arrangements, by contrast, use is made of planar substrates on both sides, such as transparent or non-transparent films, which can be embodied in multilayer fashion. Combinations of different polymers as well as inorganic or organic layers can be used in this case. The use of such planar substrates enables a flexible, extremely thin construction. In this case, a wide variety of substrates such as e.g. films, woven fabrics, nonwovens and papers or combinations thereof are possible for the various applications.

In order to characterize the barrier effect, the oxygen transmission rate OTR and the water vapour transmission rate WVTR are usually specified. In this case, the respective rate indicates the area- and time-related flow of oxygen and water vapour through a film under specific conditions of temperature and partial pressure and, if appropriate, further measurement conditions such as relative air humidity. The lower these values, the better the suitability of the respective material for encapsulation. In this case, the specification of the permeation is not only based on the values for WVTR or OTR but also always includes a specification with regard to the average path length of the permeation, such as e.g. the thickness of the material, or a normalization to a specific path length.

The permeability P is a measure of how permeable a body is to gases and/or liquids. A low P value denotes a good barrier effect. The permeability P is a specific value for a defined material and a defined permeant under steady-state conditions for a specific permeation path length, partial pressure and temperature. The permeability P is the product of diffusion term D and solubility term S:

P=D*S

The solubility term S in the present case describes the affinity of the barrier adhesive composition for the permeant. In the case of water vapour, for example, a low value is achieved for S by hydrophobic materials. The diffusion term D is a measure of the mobility of the permeant in the barrier material and is directly dependent on properties such as the molecular mobility or the free volume. Relatively low values are often achieved for D in the case of highly crosslinked or highly crystalline materials. However, highly crystalline materials are generally less transparent and higher crosslinking leads to a lower flexibility. The permeability P usually rises with an increase in molecular mobility, for instance even if the temperature is increased or the glass transition point is exceeded.

Approaches for increasing the barrier effect of an adhesive composition have to take account of the two parameters D and S in particular with regard to the influence on the permeability of water vapour and oxygen. In addition to these chemical properties, effects of physical influences on the permeability also have to be considered, in particular the average permeation path length and interface properties (flowing behaviour of the adhesive composition, adhesion). The ideal barrier adhesive composition has low D values and S values in conjunction with very good adhesion on the substrate.

A low solubility term S is usually insufficient for achieving good barrier properties. One classic example of this is siloxane elastomers, in particular. The materials are extremely hydrophobic (small solubility term) but have a comparatively small barrier effect against water vapour and oxygen as a result of their freely rotatable Si—O bond (large diffusion term). A good balance between solubility term S and diffusion term D is necessary, therefore, for a good barrier effect.

To date, liquid adhesives and adhesives based on epoxides have primarily been used for the encapsulation (WO98/21287 A1; U.S. Pat. No. 4,051,195 A; U.S. Pat. No. 4,552,604 A). These have a low permeability D as a result of high crosslinking. Their main area of use is edge adhesive bondings of rigid arrangements, but also moderately flexible arrangements. Curing is effected thermally or by means of UV radiation. A whole-area adhesive bonding is virtually impossible on account of the shrinkage occurring as a result of the curing, since stresses occur between adhesive and substrate during curing, which stresses can in turn lead to delamination.

The use of said liquid adhesives entails a series of disadvantages. This is because low-molecular-weight constituents (VOC-volatile organic compound) can damage the sensitive electronic structures of the arrangement and hinder handling in production. The adhesive has to be applied to each individual constituent of the arrangement in a complicated manner. It is necessary to procure expensive dispensers and fixing devices in order to ensure accurate positioning. Moreover, the manner of application prevents a fast continuous process and the lamination step subsequently required can also make it more difficult to achieve a defined layer thickness and adhesive bonding width within narrow limits as a result of the low viscosity.

Furthermore, such highly crosslinked adhesives have only a low flexibility after curing. The use of thermally crosslinking systems is limited in the low temperature range or in two-component systems by the pot life, that is to say the processing time until gelation has taken place. In the high temperature range and in particular in the case of long reaction times, the sensitive (opto)electronic structures in turn limit the usability of such systems—the maximum temperatures that can be employed in the case of (opto)electronic structures are often around 60° C. since preliminary damage can already occur starting at this temperature. In particular flexible arrangements which contain organic electronics and are encapsulated with transparent polymer films or composites composed of polymer films and inorganic layers impose narrow limits here. This also applies to lamination steps under high pressure. In order to achieve an improved durability, what is advantageous here is dispensing with a thermally loading step and lamination under lower pressure.

As an alternative to the thermally curable liquid adhesives, radiation-curing adhesives are now also being used in many cases (US 2004/0225025 A1). The use of radiation-curing adhesives avoids a lengthy thermal loading of the electronic arrangement. However, the irradiation gives rise to a momentary heating of the arrangement at points, since in general a very high proportion of IR radiation is also emitted alongside a UV radiation. Further abovementioned disadvantages of liquid adhesives such as VOC, shrinkage, delamination and low flexibility are likewise retained. Problems can arise as a result of additional volatile constituents or dissociation products from the photoinitiators or sensitizers. In addition, the arrangement has to be transmissive to UV light.

Since constituents of organic electronics, in particular, and many of the polymers used are often sensitive to UV loading, relatively lengthy exterior use is not possible without further additional protective measures, for instance further covering films. The latter can only be applied after UV curing in the case of UV-curing adhesive systems, which additionally increases the manufacturing complexity and the thickness of the arrangement.

US 2006/0100299 A1 discloses a UV-curable pressure-sensitive adhesive tape for encapsulating an electronic arrangement. The pressure-sensitive adhesive tape comprises an adhesive composition based on a combination of a polymer having a softening point of greater than 60° C., a polymerizable epoxy resin having a softening point of less than 30° C. and a photoinitiator. The polymers can be polyurethane, polyisobutylene, polyacrylonitrile, polyvinylidene chloride, poly(meth)acrylate or polyester, but in particular an acrylate. A UV crosslinking is effected in order to achieve a sufficient shear strength.

Acrylate compositions have a very good resistance to UV radiation and various chemicals, but have very different bond strengths on different substrates. While the bond strength on polar substrates such as glass or metal is very high, the bond strength on non-polar substrates such as polyethylene or polypropylene, for example, is rather low. Here there is the risk of diffusion at the interface to a pronounced extent. Moreover, these compositions are highly polar, which fosters a diffusion of water vapour, in particular, despite subsequent crosslinking. This tendency is further amplified by the use of polymerizable epoxy resins.

The embodiment as a pressure-sensitive adhesive composition mentioned in US 2006/0100299 has the advantage of a simple application, but likewise suffers from possible dissociation products as a result of the photoinitiators contained, a necessary UV transmissivity of the construction and a reduction of the flexibility after curing. Moreover, owing to the small proportion of epoxy resins or other crosslinkers, which is necessary for maintaining the tack and in particular the cohesion, the crosslinking density that can be achieved is only very much lower than that which can be achieved by means of liquid adhesives.

WO 2007/087281 A1 discloses a transparent flexible pressure-sensitive adhesive tape based on polyisobutylene (PIB) for electronic applications, in particular OLED. Polyisobutylene having a molecular weight of more than 500 000 g/mol and a hydrogenated cyclic resin are used in this case. The use of a photopolymerizable resin and of a photoinitiator is optionally possible. On account of their low polarity, adhesive compositions based on polyisobutylene have a good barrier against water vapour, but a relatively low cohesiveness even at high molecular weights, for which reason even at room temperature, and in particular at elevated temperatures, under loading a tendency to creepage can be ascertained and they therefore have a low shear strength. The fraction of low-molecular-weight constituents cannot be reduced arbitrarily since otherwise the adhesion is significantly reduced and the interface permeation increases. When using a high fraction of functional resins, which is necessary on account of the very low cohesion of the composition, the polarity of the composition is increased again and the solubility term is thus increased.

By contrast, a pressure-sensitive adhesive composition with pronounced crosslinking for reducing the tendency to creepage exhibits good cohesion, but the flow behaviour is impaired. The pressure-sensitive adhesive composition can adapt to the roughness of a substrate surface only to an insufficient extent, whereby the permeation at the interface is increased. Moreover, a pressure-sensitive adhesive composition with pronounced crosslinking can dissipate deformation energy, such as occurs under loading, only to a relatively small extent. The bond strength is reduced by both phenomena. By contrast, a slightly crosslinked pressure-sensitive adhesive composition can indeed readily flow on rough surfaces and dissipate deformation energy, such that the requirements made of adhesion can be met, but the pressure-sensitive adhesive composition withstands a loading only to an inadequate extent on account of a reduced cohesion.

The prior art additionally discloses a pressure-sensitive adhesive composition without barrier properties (WO 03/065470 A1), which is used as a transfer adhesive composition in an electronic construction and is not described in any more detail. The adhesive composition contains a functional filler that reacts with oxygen or water vapour within the construction. A simple application of a scavenger within the construction is thus possible. For sealing the construction towards the outside, a further adhesive having low permeability is used.

The use of polyolefin-based hot melt adhesives is known, such as are customary in the packaging sector, e.g. carton sealing hot melt adhesives and sealing layers in film packagings which essentially bond adhesively onto themselves, including in (opto)electronic constructions. However, these have the disadvantage that they have to be heated for the adhesive bonding, which entails the risk of damage to the electronic construction.

Pressure-sensitive adhesives generally require a certain time, sufficient pressure and a good balance between viscose fraction and elastic fraction owing to the relatively high-molecular-weight polymers in contrast to liquid and hot melt adhesives for a good wetting and adhesion on the surface. The subsequent crosslinking of the adhesion compositions generally leads to a shrinkage of the composition. This can lead to a reduction of the adhesion at the interface and in turn increase the permeability.

In order to achieve a best possible sealing and simple handling, there is a need for an adhesive composition with barrier properties and avoidance of the outlined disadvantages of the solution approaches based on pressure-sensitive adhesives. A good adhesive composition for the sealing of (opto)electronic components is intended to have a low permeability to oxygen and in particular to water vapour, sufficient adhesion on the arrangement and good flow. A low adhesion on the arrangement reduces the barrier effect at the interface, thereby enabling oxygen and water vapour to enter independently of the properties of the adhesive composition. It is only if the contact between composition and substrate is continuous that the properties of the composition are the determining factor for the barrier effect of the adhesive composition. Even if the adhesive tape carrier has good barrier properties, the permeation through the adhesive composition is a weak spot. This is a point of weakness in previous endeavors to use pressure-sensitive adhesives based on acrylate, polyurethane or silicone for such applications. Therefore, it is desirable to minimize the cross-sectional area of the pressure-sensitive adhesive with respect to the atmosphere, that is to say that the layer thickness (application of composition) is to be small. In order nevertheless to achieve sufficient adhesion, the pressure-sensitive adhesive should have the property of adhering well despite little application of composition.

It is an object of the present invention to specify a method for encapsulating an electronic arrangement against permeants, in particular water vapour and oxygen, which can be carried out in a simple manner and by means of which at the same time a good encapsulation is obtained. Furthermore, the intention is to increase the lifetime of (opto)electronic arrangements by the use of a suitable, in particular flexible, adhesive composition.

The present invention solves the problem described above by means of a method described hereinbelow.

The present invention is firstly based on the insight that, despite the disadvantages described above, it is nevertheless possible to use a pressure-sensitive adhesive composition for encapsulating an electronic arrangement in the case of which the disadvantages described above with regard to pressure-sensitive adhesive compositions do not occur or occur only to a reduced extent. It has been found that a pressure-sensitive adhesive composition based on specific polyolefins is particularly suitable for encapsulating electronic arrangements. Based on polyolefins in this sense means that the polyolefin predominantly performs the function of the elastomer component. Preferably, polyolefin is provided by itself as elastomer component or else at any rate to the extent of at least 50% by weight relative to the total fraction of all elastomer components.

The specific polyolefins are those which have a density of between 0.86 and 0.89 g/cm³ and also a crystallite melting point of at least 90° C. The lower density limit defines the polyolefins which have a sufficient crystal structure. If the crystalline fraction is too high, however, the polyolefins become hard and are no longer suitable for use in an adhesive composition. Said limit is specified by the maximum density. In particular, polyolefins of this type are combined with a tackifier resin. The resulting pressure-sensitive adhesive composition is preferably tacky at 23° C. Partly crystalline polyolefins have not been used for pressure-sensitive adhesive applications hitherto since it appeared to the person skilled in the art to be impossible to impart tacky properties to them. After this was able to be achieved, it was all the more surprising that precisely this novel type of pressure-sensitive adhesive composition has proved to be particularly suitable for encapsulation applications.

Conventional partly crystalline polyolefins such as are known for thermoplastic processing, for example polyethylene or polypropylene or the copolymers thereof having slightly reduced crystallinity and flexural modulus, have no tack whatsoever even by adding tackifier resins.

Specific soft polyolefins having little or completely lacking crystallinity such as butyl or EPDM rubber are not tacky either, that is to say that they have no significant bond strength. Very smooth layers composed of such soft polyolefins can readily adhere on very smooth substrates such as glass or plastic glasses and they behave like equally smooth layers composed of natural rubber, butyl rubber or highly plasticized PVC. Such materials can hold their own weight, such that they do not automatically fall off, but have practically no resistance under peeling loading since their glass transition temperature is much too low compared with a pressure-sensitive adhesive. Furthermore, such materials tend to coalesce during storage since adequate crystallinity is not present or they are already supplied as a block (bale). Even in the form of a pressure sensitive adhesive, they have a cold flow, which is intensified still further by the addition of tackifier resin with the aim of increasing the bond strength.

Random copolymers having a high comonomer fraction, also called plastomers, are offered as flexibilizers for hard polyolefins, are soft and have low crystallinity and can therefore be set in an adhesive fashion, in principle, but have a crystallite melting point of between 40° C. and 60° C., depending on the type, and therefore cannot produce pressure-sensitive adhesives having thermal shear strength. It has furthermore been found that with the use of a tackifier resin, the crystallite melting peak (determined by differential scanning calorimetry (DSC)) of polyolefin plastomers which have a melting point of significantly less than 100° C. is lost in an adhesive formulation comprising a tackifier resin and optionally a plasticizer, that is to say that even at room temperature there is no shear strength owing to a lack of network formation due to crystalline regions. Therefore, such soft plastomers are only suitable for resin-free or at least low-resin and plasticizer-free surface protection films where there is no requirement made with regard to a significant bond strength (that is to say above 0.1 N/cm) and thermal stability.

The adhesive composition according to the invention as described below, is provided in a manner based on a specific polyolefin and is applied onto the regions of the electronic arrangement which are to be encapsulated. Since the adhesive composition is a pressure-sensitive adhesive composition, application is particularly simple since there is no need to effect pre-fixing or the like. Depending on the configuration of the pressure-sensitive adhesive composition, subsequent treatment is no longer necessary either. Moreover, administration as pressure-sensitive adhesive tape means that the amount of pressure-sensitive adhesive composition to be applied can be simply apportioned and automatically applied. In addition, with the use of a polyolefin-based pressure-sensitive adhesive composition, no solvent emissions arise if said composition is coated from the melt.

The pressure-sensitive adhesive composition which is used according to the invention for methods for encapsulating electronic arrangements contains a partly crystalline polyolefin having a density of between 0.86 and 0.89 g/cm³, preferably between 0.86 and 0.88 g/cm³, particularly preferably between 0.86 and 0.87 g/cm³. The crystallite melting point is at least 90° C., preferably at least 115° C., particularly preferably at least 135° C. In addition, in a preferred configuration, the pressure-sensitive adhesive composition contains a tackifier resin. Tackifier resins are additives having a higher glass transition temperature than the polymer that is to be tackified, in order to increase the bond strength of the pure polymer. Methods for encapsulating optoelectronic arrangements are preferred.

Pressure-sensitive adhesive compositions within the meaning of this invention also include compositions which, although they are not tacky at room temperature, nevertheless do have these properties above room temperature but below 100° C., in particular below 70° C. Compositions of this type are preferred if the shear strength at elevated use temperatures is of primary importance. Therefore, they are stuck on at elevated temperature, which, however, does not lie above 100° C. owing to potential damage to the arrangement. Preference is given to compositions which are tacky at 23° C., such that application can be effected more simply without the action of heat, thereby also precluding thermal damage to the electronic arrangement.

In the field of adhesives, pressure-sensitive adhesive compositions are distinguished in particular by their permanent tack and flexibility. A material having permanent tack has to have a suitable combination of adhesive and cohesive properties at every point in time. This characteristic distinguishes the pressure-sensitive adhesive compositions from reactive adhesives, for example, which afford hardly any cohesion in the unreacted state. For good adhesion properties it is necessary to adjust pressure-sensitive adhesive compositions such that there is an optimum balance between adhesive and cohesive properties.

In the present case, encapsulation denotes not only an all-encompassing enclosure with said pressure-sensitive adhesive composition but also even a regional application of the pressure-sensitive adhesive composition on the regions of the (opto)electronic arrangement that are to be encapsulated, for example a covering on one side or a framing of an electronic structure.

By virtue of the selection of the constituents of the pressure-sensitive adhesive composition and the resultant very low polarity resulting from a non-polar polyolefin (described below) in combination with non-polar tackifier resins having a high softening temperature, a low permeation capability of permeants such as water vapour and oxygen, but in particular of water vapour, is achieved. In comparison with pure polyolefin films and other pressure-sensitive adhesive compositions, a further reduction of the oxygen permeability is additionally achieved in particular advantageous embodiments.

By means of further components, as described below, depending on the requirements of the (opto)electronic arrangement, it is possible, for instance by means of a crosslinking reaction, for the properties to be advantageously adapted to the requirements.

The advantage of this present invention, then in comparison with other pressure-sensitive adhesive compositions, is the combination of good barrier properties with respect to oxygen and primarily with respect to water vapour in conjunction with good interface adhesion on different substrates, in particular on non-polar substrates (which have so-called low surface energy (LSE) surfaces), good cohesive properties as a result of the network formation of the crystallites and, in comparison with liquid adhesives, a higher flexibility and simple application in the (opto)electronic arrangement and during/in the encapsulation. Depending on the embodiment of the pressure-sensitive adhesive composition, adhesive compositions based on polyolefins afford a good resistance to chemicals and ambient influences such as heat, liquid or light. Furthermore, specific embodiments also comprise transparent adhesive compositions, which can be employed especially for use in (opto)electronic arrangements since a reduction of incident or emerging light is kept very small.

The pressure-sensitive adhesive composition based on the partly crystalline polyolefins described is therefore distinguished not only by good processability and coatability but also by good product properties with regard to adhesion and cohesion and by a good barrier effect with respect to oxygen and a very good barrier effect with respect to water vapour, in particular in comparison with pressure-sensitive adhesive compositions based on acrylates, silicones, ethylene vinyl acetate, and specific embodiments of styrene block copolymers (vinylaromatic block copolymers composed of styrene and 1,3-dienes).

Such a pressure-sensitive adhesive composition can be integrated in a simple manner into an electronic arrangement, in particular also into such an arrangement requiring high flexibility. Further particularly advantageous properties of the pressure-sensitive adhesive composition are similarly good adhesion on different substrates, in particular on low energy surfaces, high shear strength and high flexibility. Moreover, a low interface permeation is also obtained as a result of a very good adhesion to the substrate.

Adhesive compositions based on natural rubber, styrene block copolymer and/or acrylate are usually used in the adhesive bonding of low energy surfaces. The natural rubber adhesive compositions often contain solvents and have a low ageing and UV stability. Styrene block copolymer adhesive compositions, generally based on a styrene-isoprene-styrene block copolymer, can be processed in a solvent-free fashion, but likewise have a low ageing and UV stability. Both types of rubber compositions have good adhesion on low energy surfaces. Adhesive compositions based on hydrogenated styrene block copolymers are very expensive, but have comparatively low tack and bond strength. They likewise already soften at significantly less than 100° C. Acrylate adhesive compositions have a good ageing and UV stability, but despite all previous endeavors adhere only poorly on low energy, non-polar polymers, such as polyolefins, for example, for which reason the surfaces that are to be adhesively bonded have to be pretreated with solvent-containing primers. Silicone pressure-sensitive adhesives have a good ageing and UV stability and good adhesion on low energy surfaces, but are extremely expensive and cannot be covered with the customary siliconized liners (or cannot be removed from them again). Advantageous arrangements that combine the abovementioned advantages and thereby accelerate and simplify the encapsulation process are obtained by the use of the formulations described here for the encapsulation of (opto)electronic structures.

Since, in specific embodiments of the pressure-sensitive adhesive composition, no thermal process steps or irradiation are/is necessary, no shrinkage occurs as a result of a crosslinking reaction and the pressure-sensitive adhesive composition is present as a web-type material or in a form correspondingly adapted to the electronic arrangement, it is the case that the composition can be integrated into the process for the encapsulation of the (opto)electronic construction simply and rapidly under low pressure. The disadvantages usually associated with the different processing steps, such as thermal and mechanical loadings, can thus be minimized. An encapsulation by lamination of at least parts of the (opto)electronic structures with a planar barrier material (e.g. glass, in particular thin glass, metal-oxide-coated films, metal films, multilayer substrate materials) is possible with a very good barrier effect in a simple roll-to-roll process. The flexibility of the entire construction depends, besides the flexibility of the pressure-sensitive adhesive composition, on further factors, such as geometry and thickness of the (opto)electronic structures or the planar barrier materials. The high flexibility of the pressure-sensitive adhesive composition makes it possible, however, to realize very thin, pliable and flexible (opto)electronic structures. The term “pliable” used should be understood to mean the property that the curvature of a curved object such as a drum with a specific radius, in particular with a radius of 5 mm, is followed without damage.

It is particularly advantageous for the encapsulation of (opto)electronic constructions if the latter are heated before, during or after the application of the pressure-sensitive adhesive composition. As a result, the pressure-sensitive adhesive composition can flow better and it is thus possible to reduce the permeation at the interface between the (opto)electronic arrangement and the pressure-sensitive adhesive composition. In this case, the temperature should be preferably more than 30° C., more preferably more than 50° C., in order to correspondingly promote the flowing. The temperature should not be chosen to be too high, however, in order not to damage the (opto)electronic arrangement. The temperature should as far as possible be less than 100° C. Temperatures of between 50° C. and 70° C. have been found to be an optimum temperature range. It is likewise advantageous if the pressure-sensitive adhesive composition is additionally or alternatively heated before, during or after the application.

In a preferred configuration of a method for encapsulating an electronic arrangement against permeants, the pressure-sensitive adhesive composition can be provided as part of an adhesive tape. This type of presentation permits a particularly simple and uniform application of the pressure-sensitive adhesive composition.

In this case, in one embodiment, the general expression “adhesive tape” encompasses a carrier material provided with a pressure-sensitive adhesive composition on one or both sides. The adhesive composition can also be applied in multilayer fashion. In the case of a multilayer construction, a plurality of layers can be applied one above another by coextrusion, lamination or coating. The carrier material encompasses all planar structures, for example two-dimensionally extended films or film sections, tapes having an extended length and limited width, tape sections, diecuts, multilayer arrangements and the like. In this case, for different applications it is possible to combine a wide variety of carriers such as e.g. plastic and metal films, woven fabrics, nonwovens and papers with the adhesive compositions.

Furthermore, the expression “adhesive tape” also encompasses so-called “transfer adhesive tapes”, that is to say an adhesive tape without a carrier. In the case of a transfer adhesive tape, rather, the adhesive composition is applied prior to application between (flexible) liners that are provided with a release layer with anti-adhesive properties. Application regularly involves firstly removing one liner, applying the adhesive composition and then removing an optional second liner. The pressure-sensitive adhesive composition can thus be used directly for connecting two surfaces in (opto)electronic arrangements.

The expression “adhesive tape” encompasses adhesive tape not only in roll form but also as segments or diecuts; the latter are commonly also referred to as labels.

In the present case, polymer films, film composites or films or film composites provided with organic and/or inorganic layers are preferably used as the carrier material of an adhesive tape. Such films/film composites can comprise all conventional plastics, glasses or metals used for film production, and the following shall be mentioned by way of example but not restrictively:

polyethylene, polypropylene, cyclic olefin copolymers (COC), polyvinyl chloride (PVC), polyester—in particular polyethylene terephthalate (PET) and polyethylene napthalate (PEN), ethylene vinyl alcohol (EVOH), polyvinylidene chloride (PVDC), polyvinylidene fluoride (PVDF), polyacrylonitrile (PAN), polycarbonate (PC), polyamide (PA), polyether sulphone (PES), polyimide (PI) or metal films such as aluminium foil.

The carrier can additionally be combined with organic or inorganic coatings or layers. This can be done by means of customary methods such as e.g. lacquering, printing, vapour deposition, sputtering, coextrusion or lamination. By way of example, but not restrictively, mention shall be made here for instance of metals, oxides or nitrides of silicon and of aluminium, indium tin oxide (ITO) or organometallic compounds such as are used in sol-gel coatings, for instance.

Particularly preferably, said films/film composites, in particular the polymer films, are provided with a permeation barrier for oxygen and water vapour, wherein the permeation barrier exceeds the requirements for the packaging sector (WVTR<10⁻¹ g/(m²d); OTR<10⁺¹ cm³/(m²d bar)). The permeability for oxygen (OTR) and water vapour (WVTR) is determined according to DIN 53380 part 3 and ASTM F-1249, respectively. The oxygen permeability is measured at 23° C. and a relative humidity of 50%. The water vapour permeability is determined at 37.5° C. and a relative humidity of 90%. The results are normalized to a film thickness of 50 μm.

Depending on the requirements of the (opto)electronic arrangement, in one specific embodiment of the pressure-sensitive adhesive composition, the elastic and viscous properties and also the barrier effect can be varied by means of a (subsequent) crosslinking reaction. This can take place in a manner adapted to the (opto)electronic arrangement both thermally and by means of electromagnetic radiation, preferably UV radiation, electron radiation or gamma radiation. The high flexibility of the pressure-sensitive adhesive composition is maintained in this case, however. More preferably, the crosslinking, if necessary, is effected before the application of the pressure-sensitive adhesive composition on the electronic arrangement. In this way a supply of energy possibly required for the crosslinking, for example in the form of heat or by means of UV irradiation or the like, cannot impair the electronic structures.

More preferably, a pressure-sensitive adhesive composition is used which, in specific embodiments, is transparent in the visible light of the spectrum (wavelength range of approximately 400 nm-800 nm). In this case, “transparency” means an average transmission of the adhesive composition in the visible light range of at least 75%, preferably higher than 90%. In the case of the embodiment as a pressure-sensitive adhesive tape with carrier, the maximum transmission of the entire construction is additionally dependent on the type of carrier used and the type of construction. The desired transparency can be achieved in particular by using colourless tackifier resins.

The transmission of the adhesive composition was determined over the VIS spectrum. The recordings of the VIS spectrum were carried out on a UVIKON 923 from Kontron. The wavelength range of the measured spectrum encompasses all frequencies between 400 nm and 800 nm at a resolution of 1 nm. For this purpose, the adhesive composition was applied to a PET carrier and the measurement was preceded by carrying out an idle channel measurement of the carrier as reference over the entire wavelength range. The result was specified by averaging the transmission measurements in the specified range.

Such a pressure-sensitive adhesive composition is thus also suitable for a whole-area use over an (opto)electronic structure. A whole-area adhesive bonding affords the advantage over an edge sealing, in the case of an approximately central arrangement of the electronic structure, that the permeant would have to diffuse through the entire area before reaching the structure. The permeation distance is therefore significantly increased. The permeation distances lengthened in this embodiment in comparison with edge sealing by means of liquid adhesives, for instance, have a positive effect on the overall barrier since the permeation distance is inversely proportional to the permeability.

The electronic structures of (opto)electronic arrangements are often susceptible to UV radiation. It has been found to be particularly advantageous, therefore, if the pressure-sensitive adhesive composition is additionally embodied in a UV-blocking fashion. In the present case, the term “UV-blocking” denotes an average transmittance of at most 20%, preferably of at most 10%, more preferably of at most 1%, in the corresponding wavelength range. In a preferred configuration, the pressure-sensitive adhesive composition is embodied in UV-blocking fashion in the wavelength range of 320 nm to 400 nm (UVA radiation), preferably in the wavelength range of 280 nm to 400 nm (UVA and UVB radiation), more preferably in the wavelength range of 190 nm to 400 nm (UVA, UVB and UVC radiation).

The UV-blocking effect of the pressure-sensitive adhesive composition can be achieved in particular by adding light stabilizers such as UV absorbers or suitable fillers to the pressure-sensitive adhesive composition. Examples of suitable light stabilizers include HALS (Hindered Amine Light Stabilizer), benzimidazole derivatives and further light stabilizers such as are known to the person skilled in the art for example by the trade name Chimassorb or Tinuvin from Ciba. Titanium dioxide, in particular, is suitable as a filler owing to the high UV absorption, especially nanoscale titanium dioxide, which has a transparency including in the visible range.

In comparison with conventional pressure-sensitive adhesive compositions based on natural or synthetic rubbers such as styrene-diene block copolymers, the pressure-sensitive adhesive composition described exhibits a very good resistance to heat, weathering influences and UV light. This resistance is ensured in particular by using hydrogenated resins.

The described pressure-sensitive adhesive composition used for methods for encapsulating electronic arrangements contains a partly crystalline polyolefin having a density of between 0.86 and 0.89 g/cm³ and has a crystallite melting point of at least 90° C. As is familiar to the person skilled in the art, (partial) crystallinity can be ascertained by DSC if the diagram has at least one endothermic melting peak. Partly crystalline polyolefins such as polyethylene or polypropylene were previously deemed by the person skilled in the art to be unsuitable for pressure-sensitive adhesive compositions on account of the hardness and the high tendency to crystallization. Surprisingly, from polyolefins having the stated properties, it is possible to produce pressure-sensitive adhesive compositions having high ageing resistance, bond strength, tack and shear strength which have an outstanding adhesion on very many substrates, in particular including on low energy surfaces such as non-polar lacquers or olefin polymers. Moreover, they have an outstanding barrier effect against water and oxygen, in particular against water vapour. The polyolefin preferably has a melt flow index of 0.5 to 10 g/10 min, particularly preferably 3 to 8 g/10 min. The flexural modulus of the polyolefin is preferably less than 50 MPa, particularly preferably less than 26 MPa.

The polyolefin used for the encapsulation preferably contains ethylene, propylene or but-(1)-ene as principal component in terms of weight and at least one further comonomer selected from the C2 to C10 olefins, particularly preferably from the C2 to C10 α-olefins and 4-methylpent-(1)-ene. Copolymers composed of propylene and ethylene, ethylene and octene, but-(1)-ene and propylene and also terpolymers composed of propylene, but-(1)-ene and ethylene and propylene, but-(1)-ene and 4-methylpent-(1)-ene are particularly suitable.

The polyolefin may have been constructed in various ways, for example as random copolymer, block copolymer, as graft polymer or as so-called reactor blend as in the case of heterophasic polypropylenes (also called impact polypropylene or—not quite correctly but commonly—polypropylene block copolymer).

The size of the crystals (the average diameter thereof) of the polyolefin is preferably less than 100 nm, as a result of which the adhesive composition has a high transparency.

Such a polyolefin can be produced using a metallocene catalyst based on zirconium, for example. The polyolefin preferably has a haze value of less than 8 (measured on 2 mm thick blanks in cyclohexanol).

The density of the polyolefin is determined according to ISO 1183 and expressed in g/cm³. The melt flow index is tested according to ISO 1133 with 2.16 kg and expressed in g/10 min. The values mentioned in this patent specification are determined, in the manner familiar to the person skilled in the art, at various temperatures depending on the main monomer of the polymer, said temperature being 190° C. in the case of polymers predominantly containing ethylene or 1-butene and 230° C. in the case of polymers predominantly containing propylene. The flexural modulus should be determined according to ASTM D 790 (2% secant). The crystallite melting point (T_{cr}) and the enthalpy of fusion are determined according to ISO 3146 by means of DSC (Mettler DSC 822) at a heating rate of 10° C./min, and in the case where a plurality of melting peaks occur, the one with the highest temperature is chosen since only melting peaks above 100° C. are maintained and take effect in pressure-sensitive adhesive formulations, whereas melting peaks considerably below 100° C. essentially are not maintained and have no effect on the product properties. The enthalpy of fusion determines firstly the bond strength and tack of the formulation and secondly the shear strength, in particular in heat (that is to say at 70° C. or higher). The enthalpy of fusion of the polyolefin is therefore of importance for the optimum compromise of the technical adhesive properties; it is preferably between 3 and 15 J/g, particularly preferably between 5 and 18 J/g. The enthalpy of fusion of the pressure-sensitive adhesive composition itself is likewise of importance for an optimum compromise of the technical adhesive properties; it is preferably between 1 and 6 J/g, particularly preferably between 2 and 5 J/g.

The content of polyolefin in the adhesive composition is preferably less than 60% by weight, particularly preferably less than 40% by weight, and in particular less than 30% by weight, if a particularly good tack (grab, adhesiveness) is intended to be achieved for the pressure-sensitive adhesive composition.

In another embodiment, the content of polyolefin in the adhesive composition is preferably greater than 30% by weight, especially preferably greater than 50% by weight, if a particularly good permeation barrier against water vapour is intended to be achieved. In this case it may be necessary to heat the adhesive composition directly prior to application in order to obtain sufficient adhesion. However, the increased oxygen permeation on account of the reduced resin fraction is disadvantageous here.

The polyolefin can be combined with the elastomers that are known in the case of rubber compositions, such as natural rubber or synthetic rubbers. Preferably, unsaturated elastomers such as natural rubber, SBR, NBR or unsaturated styrene block copolymers are used only in small amounts or particularly preferably not used at all. Synthetic rubbers saturated in the main chain such as polyisobutylene, butyl rubber, EPM, HNBR, EPDM or hydrogenated styrene block copolymers are preferred for the case of a desired modification. They additionally exhibit a better weathering resistance than unsaturated types. In order to achieve good transparency, however, it is preferably not combined with a rubber.

It has surprisingly been found that adhesiveness (tack) and bond strength of the polyolefin-based adhesive composition, in contrast to conventional rubber compositions, are extremely dependent on the polydispersity of the added resin. The polydispersity is the ratio of weight average to number average of the molar mass distribution and can be determined by gel permeation chromatography. Tackifier resins used, therefore, are those having a polydispersity of less than 2.1, preferably less than 1.8, particularly preferably less than 1.6. The highest tack can be achieved with resins having a polydispersity of 1.0 to 1.4.

As tackifier resin for the pressure-sensitive adhesive composition it has been found that resins based on rosin (for example balsam resin) or rosin derivatives (for example disproportionated, dimerized of esterified rosin), preferably partially or fully hydrogenated, are well suited. They impart to the pressure-sensitive adhesive composition the highest tack (adhesiveness, grab) of all the tackifier resins; that is presumably owing to the low polydispersity of 1.0 to 1.2. Terpene-phenolic resins are likewise suitable, but lead only to moderate tack, yet to very good shear strength and ageing resistance. Polyterpene resins are generally less suitable on account of their wide molar mass distribution.

Hydrocarbon resins are likewise preferred since they are readily compatible, presumably on account of their polarity. They include for example aromatic resins such as coumarone-indene resins and/or resins based on styrene or a-methyl styrene or cycloaliphatic hydrocarbon resins made from the polymerization of C5 monomers such as piperylene or C5, C8 or C9 fractions from crackers. These resins are preferred in partially hydrogenated form and particularly preferred in fully hydrogenated form. Hydrocarbon resins are obtained in a particularly suitable manner by complete hydrogenation of aromatics-containing hydrocarbon resins or cyclopentadiene polymers such as, for example, Regalite 1125 or Escorez 5320. Aforementioned tackifier resins can be used either alone or in a mixture. In this case, it is possible to use resins that are liquid and also liquids that are solid at room temperature.

In order to ensure a high ageing and UV stability, hydrogenated resins having a degree of hydrogenation of at least 90%, preferably at least 95%, are preferred.

The amount of tackifier resin is preferably 130 to 350 phr, particularly preferably 200 to 240 phr (phr denotes parts by weight relative to 100 parts by weight of polymer, that is to say polyolefin in our case).

For increasing the barrier properties, preference is given to using those tackifier resins which are non-polar and have a DACP value (diacetone alcohol cloud point) above 30° C. and an MMAP value (mixed methylcylohexane aniline point) of greater than 50° C., in particular a DACP value above 37° C. and an MMAP value greater than 60° C. The DACP value and the MMAP value respectively specify the solubility in a specific solvent. A particularly high permeation barrier, in particular against water vapour, is achieved through the selection of these ranges.

The pressure-sensitive adhesive composition preferably contains one or more additives, particularly preferably selected from the group consisting of: plasticizers, primary antioxidants, secondary antioxidants, process stabilizers, light stabilizers, processing assistants, UV blockers, polymers.

In one preferred embodiment, the adhesive composition contains a liquid plasticizer such as, for example, aliphatic (paraffinic or branched), cycloaliphatic (naphthenic) and aromatic mineral oils, esters of phthalic, trimellitic, citric or adipic acid, lanolin, liquid rubbers (for example low-molecular-weight nitrile, butadiene or polyisoprene rubbers), liquid polymers composed of isobutene and/or butene, liquid resins and soft resins having a melting point of less than 40° C. based on the raw materials of tackifier resins, in particular the abovementioned classes of tackifier resin. Particular preference is given to liquid isobutene polymers such as isobutene homopolymer or isobutene-butene copolymer and esters of phthalic, trimellitic, citric or adipic acid, in particular their esters of branched octanols and nonanols. Mineral oils are very well suited to setting the polyolefin in an adhesive fashion, but can migrate into substrates that are to be adhesively bonded. Therefore, the adhesive composition is preferably substantially free of mineral oils.

Instead of a liquid plasticizer it is also possible to use a very soft and scarcely crystalline olefin polymer (plastomer) in addition to the polyolefin. This is preferably a copolymer or terpolymer composed of ethylene or propylene combined with ethylene, propylene, but-(1)-ene, hex-(1)-ene, 4methylpent-(1)-ene or oct-(1)-ene, which are known for example by the trade names Exact™, Engage™ or Tafiner™, or a terpolymer composed of ethylene, propylene and but-(1)-ene, hex-(1)-ene, 4methylpent-(1)-ene or oct-(1)-ene, the flexural modulus preferably being less than 20 MPa and/or the crystallite melting point preferably being less than 60° C. and/or the density lying between 0.86 and 0.87 g/cm³. Further preferred olefin polymers are EPDM, that is to say terpolymers composed of ethylene and propylene and a diene such as ethylidenenorbornene, preferably having an ethylene content of 40 to 70% by weight, a Mooney viscosity (conditions 1+4, 125° C.) of less than 50 and/or a density of less than 0.88, particularly preferably less than 0.87 g/cm³. Since such olefin polymers are very soft, but are relatively hard compared with a liquid plasticizer, the amount in relation to the polyolefin according to the invention should be very high, that is to say greater than 100 phr.

The melting point (softening point) of the tackifier resin (determined according to DIN ISO 4625) is likewise accorded importance. The bond strength of a rubber pressure-sensitive adhesive composition (based on natural or synthetic rubber) usually rises with the melting point of the tackifier resin. The opposite behaviour appears to prevail in the case of the polyolefins described. Tackifier resins having a high melting point of 100° C. to 140° C. are less favourable in this regard than those having a melting point of less than 100° C. If a specific application requires a high tack and high bond strength, a tackifier resin having a lower softening point is used or a commercially available product is combined with a plasticizer in order in effect to lower the melting point of the resin. The mixed melting point is determined on a homogenized mixture composed of tackifier resin and plasticizer, wherein the two components are present in the same ratio as in the corresponding adhesive composition. The melting point set and determined in this way preferably lies in the range of 45° C. to 100° C.

The barrier effect of the composition is to the fore, however, in most applications. It has been ascertained that not only the amount of resin but also the softening point is of importance for this. Therefore, if the barrier effect against oxygen is intended to be particularly pronounced and the adhesive action is still sufficient, preference is given to resins having a melting point of at least 100° C. or the corresponding mixture composed of a resin and a plasticizer.

If improving the permeation barrier is to the fore, preferably resins having a softening temperature of more than 90° C., in particular more than 100° C., are used for such embodiments. The resin/plasticizer melting points set are preferably more than 70° C., in particular more than 80° C. A high permeation barrier, in particular against oxygen, is achieved by this selection.

The softening temperature is set in a manner dependent on the requirements of the (opto)electronic construction in order to obtain an optimum balance between bond strength, tack, cohesion and barrier effect of the pressure-sensitive adhesive composition.

Conventional adhesive compositions based on natural rubber or unsaturated styrene block copolymers as elastomer component usually contain a phenolic antioxidant in order to avoid the oxidative degradation of said elastomer component with double bonds in the polymer chain. However, the adhesive composition used in the present case contains a polyolefin without oxidation-sensitive double bonds and can therefore manage even without an antioxidant. In order to optimize the properties, however, the employed self-adhesive composition or the pressure-sensitive adhesive can also be mixed with further additives such as primary and secondary antioxidants, flame retardants, pigments, UV absorbers, antiozonants, metal deactivators, light stabilizers and/or flame retardants.

Preferably, a primary antioxidant and particularly preferably also a secondary antioxidant are used. In the preferred embodiments, the adhesive compositions according to the invention contain at least 2 phr, particularly preferably 6 phr of primary antioxidant or, preferably, at least 2 phr, in particular at least 6 phr of a combination of primary and secondary antioxidants, where the primary and secondary antioxidant functions do not have to be present in different molecules, but rather can also be combined in one molecule. The amount of secondary antioxidant is preferably up to 5 phr, particularly preferably 0.5 to 1 phr. It has surprisingly been found that a combination of primary antioxidants (for example sterically hindered phenols or C-radical scavengers such as CAS 181314-48-7) and secondary antioxidants (for example sulphur compounds, phosphites or stochically hindered amines) yields an improved compatibility. Primarily, the combination of a primary antioxidant, preferably sterically hindered phenols with a relative molar mass of more than 500 daltons, with a secondary antioxidant from the class of sulphur compounds or from the class of phosphites, preferably with a relative molar mass of more than 500 daltons, is preferred, wherein the phenolic, sulphur-containing and phosphitic functions do not have to be present in three different molecules, rather it is also possible for more than one function to be combined in one molecule.

In a further embodiment, the pressure-sensitive adhesive compositions used according to the invention are crosslinked preferably before or else, if appropriate, after flowing on the surface, those degrees of crosslinking which continue to enable a high flexibility and good adhesion of the material being striven for. After crosslinking, the pressure-sensitive adhesive composition preferably has an elongation at break of at least 20%. Such an elongation at break is particularly preferred with regard to a configuration of the pressure-sensitive adhesive composition which is as flexible as possible. The elongation at break is determined at an elongation rate of 300 mm/min and a temperature of 23° C.

In one preferred procedure, the pressure-sensitive adhesive composition is crosslinked using UV radiation or electron beams. A detailed description of the prior art and the most important method parameters with regard to the crosslinking are known to the person skilled in the art for example from “Chemistry and Technology of UV and EB formulation for Coatings, Inks and Paints” (Vol. 1, 1991, SITA, London). In addition, it is also possible to use other methods that enable high-energy irradiation.

In order to reduce the radiation dose required, it is possible to admix with the viscoelastic material crosslinkers and/or promoters for crosslinking, in particular crosslinkers and/or promoters that can be excited by UV, electron beams and/or thermally. Suitable crosslinkers for radiation crosslinking are monomers or polymers which comprise the following functional groups, for example: acrylate or methacrylate, epoxide, hydroxyl, carboxyl, vinyl, vinyl ether, oxetane, thiol, acetoacetate, isocyanates, allyl or generally unsaturated compounds. The monomers or polymers used can be di- or multifunctional depending on the requirements made of the degree of crosslinking.

In a further preferred design, the pressure-sensitive adhesive compositions are crosslinked using thermally activatable crosslinkers. For this purpose, peroxides, acids or acid anhydrides, metal chelates, bi- or multifunctional epoxides, bi- or multifunctional hydroxides and bi- or multifunctional isocyanates are preferably admixed, such as described for instance for acid anhydrides in EP 1311559 B1.

Besides the monomeric crosslinkers with the functional groups described, use is preferably made of polymers that are functionalized with these crosslinking groups. Use advantageously can be made of functionalized block copolymers such as the Kraton FG series (for instance Kraton FG 1901 or Kraton FG 1924), Asahi Tuftec M 1913 or Tuftec M 1943 or Septon HG252 (SEEPS-OH). Further preferred block copolymers are obtainable for example under the name Epofriend A 1005, A 1010 or A 1020 from the company Daicel. By adding suitable crosslinking agents (for example polyfunctional isocyanates, amines, epoxides, alcohols, thiols, phenols, guanidines, mercaptans, carboxylic acids or acid anhydrides), these block copolymers can be crosslinked thermally or by means of radiation. A combination of acid- or acid-anhydride-modified block copolymer (for example Kraton FG series) and an epoxidized block copolymer (for example Daicel Epofriend series) can also advantageously be used. It is thereby possible to realize a crosslinking without a monomeric crosslinker, as a result of which no monomeric constituents remain even in the event of incomplete crosslinking. A further possibility is to use a functionalized polyisobutylene, as is obtainable under the name Epion from the company Kaneka. This can be linked by means of condensation reactions, hydrosilanes or various techniques mentioned above, such as electron beams, further crosslinkers or free-radical initiators. A mixture of functionalized monomers or polymers can likewise be used.

In a further embodiment, the pressure-sensitive adhesive composition also contains fillers; by way of example but not restrictively mention shall be made of oxides, hydroxides, carbonates, nitrides, halides, carbides or mixed oxide/hydroxide/halide compounds of aluminium, silicon, zirconium, titanium, tin, zinc, iron or alkali or alkaline earth metals. Aluminas, e.g. aluminium oxides, boehmite, bayerite, gibbsite, diaspore and the like, are essentially involved here. Phyllosilicates such as, for example, bentonite, montmorillonite, hydrotalcite, hectorite, kaolinite, boehmite, mica, vermiculite or mixtures thereof are especially suitable. However, carbon blacks or further modifications of carbon, for instance carbon nanotubes, hollow bodies composed of glass or solid glass bodies or polymers, in particular hollow spheres or glass or polymer fibres, can also be used.

Nanoscale and/or transparent fillers are preferably used as fillers of the pressure-sensitive adhesive composition. In the present case, a filler is referred to as nanoscale if it has a maximum extent of approximately 100 nm, preferably of approximately 10 nm, in at least one dimension. Particularly preferably, use is made of such fillers which are transparent in the composition and have a platelet-shaped crystallite structure and a high aspect ratio with homogeneous distribution. The fillers having a platelet-like crystallite structure and aspect ratios of far greater than 100 generally have only a thickness of a few nm; however, the length or width of the crystallites can be up to a few μm. Such fillers are likewise referred to as nanoparticles. The particulate configuration of the fillers with small dimensions is particularly advantageous, moreover, for a transparent design of the pressure-sensitive adhesive composition.

By constructing labyrinthine structures with the aid of the above-described fillers in the pressure-sensitive adhesive matrix, the diffusion distance of oxygen and water vapour, for example, is lengthened in such a way that the permeation thereof through the pressure-sensitive adhesive layer is reduced. For better dispersibility of these fillers in the binder matrix, these fillers can be superficially modified with organic compounds. The use of such fillers per se is known for example from US 2007/0135552 A1 and WO 02/026908 A1.

In a further advantageous embodiment of the present invention, fillers which can interact with oxygen and/or water vapour in a particular way are also used. Oxygen or water vapour penetrating into the (opto)electronic arrangement is then chemically or physically bound to said fillers. Said fillers are also referred to as “getter”, “scavenger”, “desiccant” or “absorber”. Such fillers comprise by way of example, but not restrictively: oxidizable metals, halides, salts, silicates, oxides, hydroxides, sulphates, sulphites, carbonates of metals and transition metals, perchlorates and activated carbon, including its modifications. Examples are cobalt chloride, calcium chloride, calcium bromide, lithium chloride, zinc chloride, zinc bromide, silicon dioxide (silica gel), aluminium oxide (activated aluminium), calcium sulphate, copper sulphate, sodium dithionite, sodium carbonate, magnesium carbonate, titanium dioxide, bentonite, montmorillonite, diatomaceous earth, zeolites and oxides of alkali or alkaline earth metals such as barium oxide, calcium oxide, iron oxide and magnesium oxide or else carbon nanotubes. Furthermore, it is also possible to use organic absorbers, for example polyolefin copolymers, polyamide copolymers, PET copolyesters or further hybrid-polymer-based absorbers, which are usually used in combination with catalysts such as cobalt, for example. Further organic absorbers are, for instance, weakly crosslinked polyacrylic acid, ascorbates, glucose, gallic acid or unsaturated fats and oils.

In order to obtain a best possible efficacy of the fillers with regard to the barrier effect, their fraction should not be too low. The fraction is preferably at least 5% by weight, more preferably at least 10% by weight, and especially preferably at least 15% by weight. A highest possible fraction of fillers is typically used, without the bond strengths of the pressure-sensitive adhesive composition being reduced to an excessively great extent or without further properties being impaired in the process. In one design, therefore, the fraction is at most 95% by weight, preferably at most 70% by weight, more preferably at most 50% by weight.

Furthermore, a finest possible distribution and highest possible surface area of the fillers are advantageous. This enables a higher efficiency and a higher loading capacity and is achieved in particular by means of nanoscale fillers.

The pressure-sensitive adhesive composition can be produced and processed from solution, dispersion and from the melt. Production and processing are preferably effected from solution or from the melt. The manufacture of the adhesive composition from solution is a preferred variant. In this case, the constituents of the pressure-sensitive adhesive composition are dissolved in a suitable solvent, for example toluene or mixtures of petroleum spirit, toluene and acetone, and applied to the carrier by generally known methods. In the case of methods from solution, coatings by means of doctor blades, knives, rollers or nozzles are known, to name just a few.

An alternative is production and processing from the melt. In this case, suitable production processes include both batch methods and continuous methods. Particular preference is given to the continuous manufacture of the pressure-sensitive adhesive composition with the aid of an extruder and subsequent coating directly onto the substrate to be coated, at a correspondingly high temperature of the adhesive composition. Preferred coating methods for pressure-sensitive adhesive compositions are extrusion coating with slot dies and calender coating and, in the case of non-tacky hot melt adhesives, slot dies, hot melt adhesive guns and nozzles for spinning adhesive threads. Further embodiments are lamination and coextrusion with a carrier (for example a film).

The pressure-sensitive adhesive composition can either be used for the whole-area adhesive bonding of (opto)electronic arrangements or after corresponding converting it is possible to produce diecuts, rolls or other shaped bodies from the pressure-sensitive adhesive composition or the pressure-sensitive adhesive tape. Corresponding diecuts and shaped bodies of the pressure-sensitive adhesive composition/pressure-sensitive adhesive tape are then preferably adhesively bonded onto the substrate to be adhesively bonded, for instance as borders or delimitation of an (opto)electronic arrangement. The choice of the shape of the diecut or of the shaped body is not restricted and is chosen depending on the type of (opto)electronic arrangement. The possibility of planar lamination is advantageous, in comparison with liquid adhesives as a result of the increase in the permeation path length as a result of lateral penetration of the permeants, for the barrier properties of the composition since a permeation path length inversely proportionally affects the permeation.

If the pressure-sensitive adhesive composition is provided in the form of a planar structure with a carrier, it is preferred for the thickness of the carrier to be preferably in the range of approximately 1 μm to approximately 350 μm, more preferably between approximately 2 μm and approximately 250 μm, and particularly preferably between approximately 12 μm and approximately 150 μm. The optimum thickness depends on the (opto)electronic arrangement, the final application and the type of embodiment of the pressure-sensitive adhesive composition. Very thin carriers in the range of 1 to 12 μm are used in the case of (opto)electronic constructions which are intended to achieve a small total thickness, but the outlay for integration into the construction is increased. Very thick carriers of between 150 and 350 μm are used if an increased permeation barrier through the carrier and the stiffness of the construction are to the fore; the protective effect is increased by the carrier, while the flexibility of the construction is reduced. The preferred range of between 12 and 150 μm represents an optimum compromise as encapsulation solution for most (opto)electronic constructions.

Further details, aims, features and advantages of the present invention are explained more comprehensively below on the basis of preferred exemplary embodiments. In the drawing:

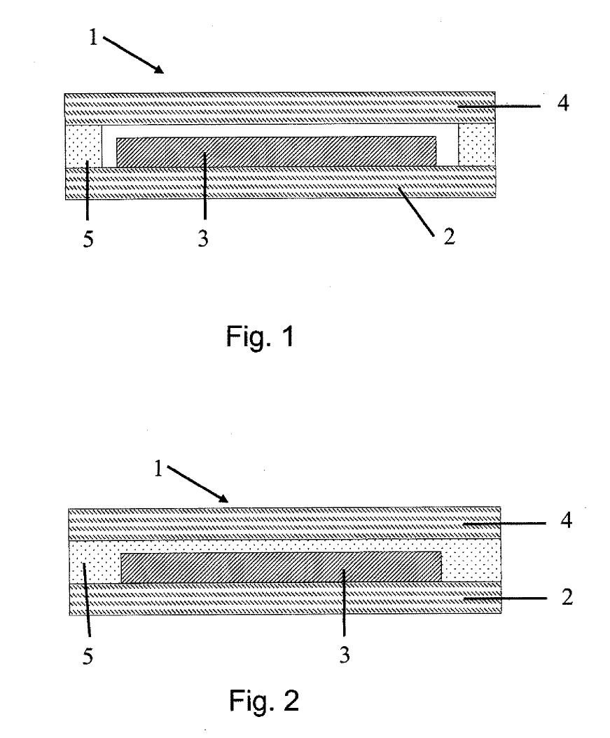

FIG. 1 shows a first (opto)electronic arrangement in schematic illustration,

FIG. 2 shows a second (opto)electronic arrangement in schematic illustration,

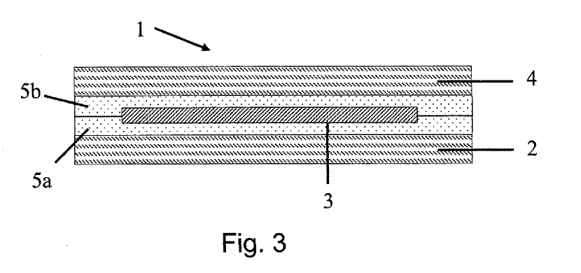

FIG. 3 shows a third (opto)electronic arrangement in schematic illustration.

FIG. 1 shows a first configuration of an (opto)electronic arrangement 1. This arrangement 1 has a substrate 2, on which an electronic structure 3 is arranged. The substrate 2 itself is embodied as a barrier to permeants and thus forms part of the encapsulation of the electronic structure 3. A further covering 4, embodied as a barrier, is arranged above the electronic structure 3, and in the present case also spatially at a distance therefrom.

In order also to encapsulate the electronic structure 3 towards the side and moreover at the same time to connect the covering 4 to the electronic arrangement 1, a pressure-sensitive adhesive composition 5 is provided circumferentially alongside the electronic structure 3 on the substrate 2. The pressure-sensitive adhesive composition 5 connects the covering 4 to the substrate 2. By means of an appropriately thick configuration, the pressure-sensitive adhesive composition 5 additionally enables the covering 4 to be spaced apart from the electronic structure 3.

The pressure-sensitive adhesive composition 5 is one based on the pressure-sensitive adhesive composition according to the invention such as was described in general form above and is set out in greater detail in exemplary embodiments below. In the present case, the pressure-sensitive adhesive composition 5 not only performs the function of connecting the substrate 2 to the covering 4 but also additionally forms a barrier layer for permeants, in order thus to encapsulate the electronic structure 2 against permeants such as water vapour and oxygen from the side as well.

In the present case, the pressure-sensitive adhesive composition 5 is additionally provided in the form of a diecut from a double-sided adhesive tape. Such a diecut enables particularly simple application.

FIG. 2 shows an alternative configuration of an (opto)electronic arrangement 1. Once again an electronic structure 3 is shown which is arranged on a substrate 2 and is encapsulated from below by the substrate 2. The pressure-sensitive adhesive composition 5 is now arranged over the whole area above and to the sides of the electronic structure. The electronic structure 3 is thus encapsulated by the pressure-sensitive adhesive composition 5 completely from above. A covering 4 is then applied to the pressure-sensitive adhesive composition 5. In contrast to the previous configuration, said covering 4 does not necessarily have to meet the stringent barrier requirements, since the barrier is already provided by the pressure-sensitive adhesive composition. The covering 4 can for example just perform a mechanical protective function; however, it can also additionally be provided as a permeation barrier.

FIG. 3 shows a further alternative configuration of an (opto)electronic arrangement 1. In contrast to the previous configurations, two pressure-sensitive adhesive compositions 5a, b are now provided, which are embodied identically in the present case. The first pressure-sensitive adhesive composition 5a is arranged over the whole area on the substrate 2. The electronic structure 3 is provided on the pressure-sensitive adhesive composition 5a, said electronic structure being fixed by the pressure-sensitive adhesive composition 5a. The composite comprising pressure-sensitive adhesive composition 5a and electronic structure 3 is then covered over the whole area by the further pressure-sensitive adhesive composition 5b, with the result that the electronic structure 3 is encapsulated from all sides by the pressure-sensitive adhesive compositions 5a, b. The covering 4 is once again provided above the pressure-sensitive adhesive composition 5b.

In this configuration, therefore, neither the substrate 2 nor the covering 4 necessarily has to have barrier properties. However, they can nevertheless be provided, in order to further restrict the permeation of permeants to the electronic structure 3.

With regard to FIGS. 2, 3, in particular, it is pointed out that the illustrations are schematic illustrations in the present case. In particular, it is not evident from the illustrations that the pressure-sensitive adhesive composition 5 is here and preferably in each case applied with a homogeneous layer thickness. At the transition to the electronic structure, therefore, a sharp edge such as there appears to be in the illustration is not formed, rather the transition is fluid and it is possible, rather, for small unfilled or gas-filled regions to remain. If appropriate, however, adaptation to the substrate can also be effected, particularly when the application is carried out under vacuum. Moreover, the pressure-sensitive adhesive composition is compressed to different extents locally, with the result that a certain compensation of the height difference at the edge structures can be effected as a result of flow processes. Moreover, the dimensions shown are not to scale, but rather serve only for better illustration. In particular the electronic structure itself is generally embodied in relatively flat fashion (often less than 1 μm thick).

In all the exemplary embodiments shown, the pressure-sensitive adhesive composition 5 is applied in the form of a pressure-sensitive adhesive tape. This can be, in principle, a double-sided pressure-sensitive adhesive tape with a carrier, or a transfer adhesive tape. A configuration as a transfer adhesive tape is chosen in the present case.

The thickness of the pressure-sensitive adhesive composition is preferably between approximately 1 μm and approximately 150 μm, more preferably between approximately 5 μm and approximately 75 μm, and particularly preferably between approximately 12 μm and 50 μm. High layer thickness of between 50 μm and 150 μm are used when the intention is to achieve improved adhesion on the substrate and/or a damping effect within the (opto)electronic construction. However, the increased permeation cross section is disadvantageous here.

If permeation is to the fore, small layer thicknesses of between 1 μm and 12 μm are used; they reduce the permeation cross section and thus the lateral permeation and the total thickness of the (opto)electronic construction. However, a reduction of the adhesion on the substrate can occur.

In the particularly preferred thickness ranges there is a good compromise between a small composition thickness and the resultant small permeation cross section, which reduces the lateral permeation, and a sufficiently thick composition film for producing a sufficiently adhesive connection. The optimum thickness depends on the (opto)electronic construction, the final application, the type of embodiment of the pressure-sensitive adhesive composition and, if appropriate, the planar substrate.

### EXAMPLES

Unless indicated otherwise, all quantitative indications in the examples below are percentages by weight or parts by weight relative to the overall formulation. Unless different conditions are specified, the measurements were carried out at 23° C. (room temperature—RT) and a relative air humidity of 50%.

### Bond Strength

The determination of the bond strength was carried out as follows: a steel surface and a polyethylene (PE) plate were used as the defined substrate. The bondable planar element under investigation was cut to a width of 20 mm and a length of approximately 25 cm, provided with a handling section, and immediately thereafter pressed onto the respectively selected substrate five times by means of a 4 kg steel roller at a speed of 10 m/min. The thickness of the pressure-sensitive adhesive layer is 30 μm. Immediately after that, the previously bonded planar element was stripped from the substrate by means of a tensile testing instrument (Zwick) at an angle of 180° at room temperature and 300 mm/min, and the force required to achieve this was measured. The measurement value (in N/cm) resulted as the average value from three individual measurements.

### Permeation

The permeability for oxygen (OTR) and water vapour (WVTR) was determined according to DIN 53380 part 3 and ASTM F-1249, respectively. For this purpose, the pressure-sensitive adhesive composition was applied with a layer thickness of 50 μm to a permeable membrane. For the oxygen permeability, measurement was effected at 23° C. and a relative humidity of 50% using a Mocon OX-Tran 2/21 measuring device. The water vapour permeability was determined at 37.5° C. and a relative humidity of 90% using a Mocon Permatran W 3/33 measuring device.

### Lifetime Test

A calcium test was used as a measure of the determination of the lifetime of an (opto)electronic construction. For this purpose, under a nitrogen atmosphere a thin calcium layer with a size of 20×20 mm² is deposited onto a glass plate. The thickness of the calcium layer is approximately 100 nm. The calcium layer is encapsulated using an adhesive tape with a PET/CPP barrier film as carrier material (WVTR=8×10⁻² g/m²*d and OTR=6×10⁻² cm³/m²*d*bar, in accordance with conditions mentioned according to ASTM F-1249 and DIN 53380 part 3 and above). The adhesive composition is applied on the CPP side of the barrier film. The adhesive tape thus obtained is applied with an all-round edge of 5 mm above the calcium level at which it adheres directly on the glass plate.

The test is based on the reaction of calcium with water vapour and oxygen as described for example by A. G. Erlat et. al. in “47th Annual Technical Conference Proceedings Society of Vacuum Coaters”, 2004, pages 654-659, and by M. E. Gross et al. in “46th Annual Technical Conference Proceedings—Society of Vacuum Coaters”, 2003, pages 89-92. In this case, the light transmission of the calcium layer is monitored, which increases as a result of the conversion into calcium hydroxide and calcium oxide. The attainment of 90% of the transmission of the construction without a calcium layer is designated as the end of the lifetime. 23° C. and 50% relative air humidity are chosen as measurement conditions. The specimens were adhesively bonded over the whole area and without any bubbles with a layer thickness of the pressure-sensitive adhesive composition of 25 μm.

### Production of the Specimens

The pressure-sensitive adhesive compositions in examples 1 to 8 and comparative example C5 were prepared from the melt in a batch process by means of a laboratory compounder at 120-190° C., depending on the crystallite melting point of the polymer. Coating is effected directly onto the substrate to be coated (siliconized release paper) at a temperature of the adhesive composition of between 120° C. and 160° C. and with a layer thickness of 30 or 50 μm. Calender coating is used as coating method. For the bond strength measurements, the pressure-sensitive adhesive composition is laminated onto a 23 μm PET film. For the permeation test, specimens were produced in the same way, but the pressure-sensitive adhesive composition was laminated onto a permeable membrane rather than a PET film, with the result that it was possible to perform a measurement on the pressure-sensitive adhesive composition.

### Formulations

### Example 1

| | | |
|---|---|---|
| Koattro KT | 24 | Copolymer of ethylene with but-(1)-ene, melt flow |
| AR 85 | | index 0.8 g/10 min, density 0.890 g/cm³, flexural |
| | | modulus 20 MPa, crystallite melting point 112° C. |
| Ondina 933 | 20 | White oil (paraffinic-naphthenic mineral oil) |
| Foral 85 | 54 | Fully hydrogenated glycerol ester of rosin with a |
| | | melting point of 85° C. and a polydispersity of 1.2 |
| Irganox 1076 | 2 | Phenolic antioxidant |

### Example 2

| | | |
|---|---|---|
| Versify | 24 | Copolymer of ethylene and propylene, melt flow index |
| DE 2400 | | 2 g/10 min, density 0.866 g/cm³, flexural modulus |
| | | 2 MPa, crystallite melting point 130° C. |
| Ondina 933 | 20 | White oil (paraffinic-naphthenic mineral oil) |
| Regalite | 54 | C5 hydrocarbon resin, aromatic, fully hydrogenated, |
| 1100 | | aromatics content after hydrogenation = 0, melting |
| | | point 100° C., polydispersity 1.4 |
| Irganox 1076 | 2 | Phenolic antioxidant |

### Example 3

| | | |
|---|---|---|
| PB 8640M | 24 | Copolymer of 1-butene with ethylene, melt flow index |
| | | 1 g/10 min, density 0.906 g/cm³, flexural modulus |
| | | 300 MPa, crystallite melting point 113° C. |
| Ondina 933 | 20 | White oil (paraffinic-naphthenic mineral oil) |
| Wingtack | 54 | Aromatically modified C5 hydrocarbon resin, melting |
| Extra | | point 95° C.; polydispersity 1.4 |
| Irganox 1076 | 2 | Phenolic antioxidant |

### Example 4

| | | |
|---|---|---|
| Softcell | 24 | Copolymer of propylene and ethylene, melt flow index |
| CA02A | | 0.6 g/10 min, density 0.870 g/cm³, flexural modulus |
| | | 20 MPa, crystallite melting point 142° C., enthalpy |
| | | of fusion 9.9 J/g |
| Ondina 933 | 20 | White oil (paraffinic-naphthenic mineral oil) |
| Foral 85 | 54 | Fully hydrogenated glycerol ester of rosin with a |
| | | melting point of 85° C. and a polydispersity of 1.2 |
| Irganox 1076 | 2 | Phenolic antioxidant |

### Example 5

| | | |
|---|---|---|
| Vistamaxx | 12 | Copolymer of propylene and ethylene; MFR = |
| VM1100 | | 4 g/10 min; MFI = 2, density 0.862 g/cm³; |
| | | crystallite melting point of 148° C. |
| Vistamaxx | 12 | Copolymer of propylene and ethylene; MFR = |
| VM3000 | | 7 g/10 min; MFI = 3, density 0.871 g/cm³; |
| | | crystallite melting point of 34° C. |
| Ondina 933 | 20 | White oil (paraffinic-naphthenic mineral oil) |
| Foral 85 | 54 | Fully hydrogenated glycerol ester of rosin with a |
| | | melting point of 85° C. and a polydispersity of 1.2 |
| Irganox 1076 | 2 | Phenolic antioxidant |

### Example 6

| | | |
|---|---|---|
| Notio PN | 24 | Terpolymer composed of propylene with the |
| 0040 | | comonomers but-(1)-ene and 4-methylpent-(1)-ene, |
| | | melt flow index 4 g/10 min; density 0.868 g/cm³; |
| | | flexural modulus 42 MPa, crystallite melting point |
| | | 159° C., enthalpy of fusion 5.2 J/g, modulus of |
| | | elasticity G′ (23° C.) 0.6 MPa, loss factor |
| | | tan δ (23° C.) 0.14 |
| Oppanol B10 | 20 | Polyisobutene; liquid; density = 0.93 g/cm³; |
| | | Mₙ = 40 000 g/mol |
| Foral 85 | 54 | Fully hydrogenated glycerol ester of rosin with a |
| | | melting point of 85° C. and a polydispersity of 1.2 |
| Irganox 1076 | 2 | Phenolic antioxidant |

### Example 7

| | | |
|---|---|---|
| Tafcelen | 24 | Terpolymer composed of 1 = butene, propylene and |
| T3714 | | ethylene, melt flow index 3 g/10 min, density |
| | | 0.860 g/cm³; flexural modulus 1 MPa, no crystallite |
| | | melting point discernible |
| Oppanol B10 | 20 | Polyisobutene; liquid; density = 0.93 g/cm³; |
| | | Mₙ = 40 000 g/mol |
| Foral 85 | 54 | Fully hydrogenated glycerol ester of rosin with a |
| | | melting point of 85° C. and a polydispersity of 1.2 |
| Irganox 1076 | 2 | Phenolic antioxidant |

### Example 8

| | | |
|---|---|---|
| Notio PN | 24 | Terpolymer composed of propylene with the |
| 0040 | | comonomers but-(1)-ene and 4-methylpent-(1)-ene, |
| | | melt flow index 4 g/10 min; density 0.868 g/cm³; |
| | | flexural modulus 42 MPa, crystallite melting point |
| | | 159° C., enthalpy of fusion 5.2 J/g, modulus of |
| | | elasticity G′ (23° C.) 0.6 MPa, loss factor |
| | | tan δ (23° C.) 0.14 |
| Ondina 933 | 20 | White oil (paraffinic-naphthenic mineral oil) |
| Foral 85 | 54 | Fully hydrogenated glycerol ester of rosin with a |
| | | melting point of 85° C. and a polydispersity of 1.2 |
| Irganox 1076 | 2 | Phenolic antioxidant |

### Comparative Example C1

| | | |
|---|---|---|
| Kraton G 1657 | 100 | SEBS with 13% block polystyrene content from |
| | | Kraton. The SEBS contained approximately 36% |
| | | diblock content. |
| Esconez 5600 | 80 | Hydrogenated HC resin with a softening point of |
| | | 100° C., from Exxon |
| Ondina G 17 | 35 | White oil comprising paraffinic and naphthenic |
| | | fractions, from Shell |

The constituents are dissolved in a mixture of petroleum spirit, toluene and acetone (6:2:2) and coated from the solution onto an untreated PET carrier (or onto a release paper siliconized with 1.5 g/m² for the permeation measurements) and dried at 120° C. for 15 min. The thickness of the adhesive layer is 30 μm or 50 μm.

### Comparative Example C2

An acrylate having the formulation 78% EHA, 19% stearyl acrylate and 3% acrylic acid was polymerized in acetone and petroleum spirit and coated from the solution onto an untreated PET carrier (or onto a release paper siliconized with 1.5 g/m² for the permeation measurements), dried at 120° C. for 15 min and crosslinked with 0.2% aluminium chelate relative to the polymer fraction. The thickness of the adhesive layer is 30 μm or 50 μm.

### Comparative Example C3

A mixture of 60% Levamelt 456 (ethylene vinyl acetate) and 40% Foral FG85 are dissolved in acetone and coated from the solution onto an untreated PET carrier (or onto a release paper siliconized with 1.5 g/m² for the permeation measurements) and dried at 120° C. for 15 min. The thickness of the adhesive layer is 30 μm or 50 μm.

### Comparative Example C4

The commercially available silicone pressure-sensitive adhesive composition Silgrip PSA529 from GE Bayer Silikons is mixed with benzoyl peroxide and coated from the solution onto an untreated PET carrier (or onto a release paper fluorosiliconized with 1.5 g/m² for the permeation measurements) and dried at 120° C. for 15 min and crosslinked. The thickness of the adhesive layer is 30 μm or 50 μm.

### Comparative Example C5

| | | |
|---|---|---|
| Notio PN | 100 | Terpolymer composed of propylene with the |
| 0040 | | comonomers but-(1)-ene and 4-methylpent-(1)-ene, |
| | | melt flow index 4 g/10 min; density 0.868 g/cm³; |
| | | flexural modulus 42 MPa, crystallite melting point |
| | | 159° C., enthalpy of fusion 5.2 J/g, modulus of |
| | | elasticity G′ (23° C.) 0.6 MPa, loss factor |
| | | tan δ (23° C.) 0.14 |

### Results

The results of the permeation measurements are shown in Table 1. The influence of the resin used on the permeation properties of the pressure-sensitive adhesive compositions is shown, inter alia. Both water vapour permeability (WVTR) and oxygen permeability (OTR) are reduced by means of non-polar resins with a high softening temperature, such as the Regalite R1100 in example 2.

TABLE 1

| | WVTR | OTR |
|---|---|---|
| | g/(m² * day) | g/(m² * day * bar) |
| Example 1 | 120 | 9580 |
| Example 2 | 23 | 6800 |
| Example 3 | 67 | 10780 |
| Example 4 | 61 | 12780 |
| Example 5 | 47 | 13400 |
| Example 6 | 20 | 2900 |
| Example 7 | 42 | 10850 |
| Example 8 | 32 | 6500 |
| C1 | 89 | 7280 |
| C2 | 320 | 40250 |
| C3 | >1000 | 62000 |
| C4 | >1000 | 75000 |
| C5 | 29 | 14100 |

Example 1, examples 4 and 5 and example 8 comprise different polyolefins that differ, inter alia, in terms of their crystallite melting point and formulation. The permeability is lowest, and thus particularly advantageous, in the case of terpolymers composed of propylene with the comonomers but-(1)-ene and 4-methylpent-(1)-ene such as are used in examples 6 and 8.

Examples 7 and 6 demonstrate an advantageous use of the plasticizer polyisobutylene Oppanol B10 instead of the white oil Ondina 933 in the other examples. This primarily reduces the water vapour permeation of the specimens.

Comparison of examples 6 and 8 with comparative example C5 shows the advantages of the pressure-sensitive adhesive compositions according to the invention with respect to hot melt adhesive compositions based on identical polymers. The resin additive further reduces the oxygen permeability with the water vapour permeability remaining approximately the same.

In comparison with other types of pressure-sensitive adhesive compositions, for instance acrylates, ethylene-vinyl acetate or silicones (comparative examples C2 to C4), the described pressure-sensitive adhesive compositions based on polyolefins have a low permeability of water vapour and oxygen, but in particular of water vapour. Pressure-sensitive adhesive compositions based on styrene block copolymers, as in example C1, exhibit a similarly low permeability, but the latter can be surpassed by particularly advantageous embodiments of polyolefin pressure-sensitive adhesive compositions. In addition, higher adhesion particularly on non-polar surfaces, such as polyethylene, for instance, is achieved by the pressure-sensitive adhesive compositions according to the invention.

| | Bond strength [N/cm] |
|---|---|
| | Steel/PET/PE |
| Example 1 | 5.5/4.2 |
| Example 2 | 8.5/5.7 |
| Example 3 | 5.1/3.9 |
| Example 4 | 5.3/3.5 |
| Example 5 | 7.3/5.2 |
| Example 6 | 9.5/5.5 |
| Example 7 | 3.9/2.8 |
| Example 8 | 12.2/5.9 |
| C1 | 3.7/1.9 |
| C2 | 6.2/3.1 |
| C3 | 4.5/0.8 |
| C4 | 4.5/2.9 |

In the case of the bond strengths, the polyolefin pressure-sensitive adhesive compositions (examples 1 to 8), even with small layer thicknesses of approximately 30 μm, exhibit good adhesion on polar and non-polar substrates and, in specific embodiments, can significantly surpass the styrene block copolymers (C1)—similar in terms of their permeation properties—in the case of the bond strengths.

| | Lifetime |
|---|---|
| | [t/h] |
| Example 2 | 378 |
| Example 6 | 405 |
| Example 8 | 389 |
| C1 | 280 |
| C2 | 29 |
| C3 | 11 |
| C4 | 14 |
| C4 | 11 |

A lengthened lifetime of optoelectronic constructions is achieved as a result of the very good adhesion on non-polar surfaces and the barrier effect of the pressure-sensitive adhesive compositions according to the invention in particular against water vapour.

1. Method for encapsulating an electronic arrangement against permeants, said method comprising applying a pressure-sensitive adhesive composition based on a partly crystalline polyolefin onto and/or around regions of the electronic arrangement which are to be encapsulated, wherein the polyolefin has a density between 0.86 and 0.89 g/cm and a crystallite melting point of at least 90° C.

2. Method according to claim 1, wherein the pressure-sensitive adhesive composition is provided in the form of an adhesive tape.

3. Method according to claim 1, which further comprises heating the pressure-sensitive adhesive composition and/or the regions of the electronic arrangement which are to be encapsulated before, during and/or after applying the pressure-sensitive adhesive composition.

4. Method according to claim 1, which further comprises crosslinking the pressure-sensitive adhesive composition after applying on the electronic arrangement.

5. Method according to claim 1, wherein applying the pressure-sensitive adhesive composition is effected without subsequent curing.

6. A process of preparing a pressure-sensitive adhesive composition for encapsulating an electronic arrangement against permeants, comprising formulating a partly crystalline polyolefin as a pressure-sensitive adhesive, wherein the polyolefin has a density of between 0.86 and 0.89 g/cm³, and the polyolefin has a crystallite melting point of at least 90° C.

7. Process according to claim 6, wherein the polyolefin has a density of between 0.86 and 0.88 g/cm³ and/or the polyolefin has a crystallite melting point of at least 115° C.

8. Process according to claim 6, which comprises combining the polyolefin with at least one tackifier resin.

9. Process according to claim 6, wherein the pressure-sensitive adhesive composition contains a hydrogenated resin.

10. Process according to claim 6, wherein the pressure-sensitive adhesive composition contains one or more additives selected from the group consisting of: plasticizers, primary antioxidants, secondary antioxidants, process stabilizers, light stabilizers, processing assistants, UV blockers, and polymers.

11. Process according to claim 6, wherein the pressure-sensitive adhesive composition contains one or more fillers.

12. Process according to claim 6, which comprises formulating the pressure-sensitive adhesive composition to be transparent.

13. Process according to claim 6, which comprises formulating the pressure-sensitive adhesive composition to block UV in the wavelength range of 320 nm to 400 nm, where an average transmittance of at most 20% is considered UV-blocking.

14. Process according to claim 6, wherein the pressure-sensitive adhesive composition has a WVTR of less than 100 g/m²d and/or wherein the pressure-sensitive adhesive composition has an OTR of less than 10 000 g/m²·d·bar.

15. Process according to claim 6, forming the pressure-sensitive adhesive composition into an adhesive tape.

16. Electronic arrangement comprising an electronic structure and a pressure-sensitive adhesive composition, wherein the electronic structure is at least partly encapsulated by the pressure-sensitive adhesive composition, and wherein the pressure-sensitive adhesive composition is based on a partly crystalline polyolefin having a density between 0.86 and 0.89 g/cm and a crystallite melting point of at least 90° C.
